(19) United States
(12) Patent Application Publication
(10) Pub. No.: US 2022/0120184 A1
(43) Pub. Date: Apr. 21, 2022

(54) EXTERNAL COMPRESSION ENGINE

(71) Applicant: Seth Gussow, Toledo, OH (US)

(72) Inventor: Seth Gussow, Toledo, OH (US)

(21) Appl. No.: 17/451,731

(22) Filed: Oct. 21, 2021

Related U.S. Application Data
(60) Provisional application No. 63/094,374, filed on Oct. 21, 2020.
(60) Provisional application No. 63/174,972, filed on Apr. 14, 2021.

(51) Int. Cl. F01B 17/02; F01B 21/04; F01B 23/10; F01B 31/08

(52) U.S. Cl. CPC F01B 17/025; F01B 31/08; F01B 23/10; F01B 21/04

(57) ABSTRACT

An external compression engine system includes an external compression engine utilizing two strokes with the external compression engine configured to operate without a compression stroke within a combustion chamber thereof. At least one source of pressurized intake gas is configured to be placed in selective fluid communication with the combustion chamber of the external compression engine, wherein the at least one source of pressurized intake gas is one of a compressor or a storage tank.

### CROSS-REFERENCE TO RELATED APPLICATIONS

This patent application claims priority to each of U.S. Provisional Patent Application Ser. No. 63/094,374, filed on Oct. 21, 2020, and U.S. Provisional Patent Application Ser. No. 63/174,972, filed on Apr. 14, 2021, the entire disclosures of which are hereby incorporated herein by reference.

### FIELD OF THE INVENTION

The present invention relates generally to an external compression engine provided as an internal combustion engine operable without a compression step, and more particularly, an internal combustion engine system having an externally provided compressor for externally compressing an air and fuel mixture and introducing the compressed air and fuel mixture into a piston cylinder having a reciprocating piston disposed therein.

### BACKGROUND OF THE INVENTION

The internal combustion engine (ICE) utilizes the combustion of a fuel and an oxidizer (usually air) within a combustion chamber to apply a direct force to a component of an engine in order to transfer the chemical energy from the combustion process to mechanical work. Many such engines include a reciprocating piston disposed within a cylinder acting as the combustion chamber. The piston is configured to reciprocate linearly within the cylinder with the piston mechanically coupled to a crankshaft in order to transfer the linear motion of the piston to rotational motion of the crankshaft, wherein each linear motion of the piston is referred to as a stroke thereof. Each stroke of the piston in turn corresponds to 180 degrees of rotation of the associated crankshaft, hence each repeated back-and-forth cycle of the piston within the cylinder corresponds to a full 360 degree revolution of the crankshaft.

Such a piston based ICE is often provided as a 2-stroke or 4-stroke engine. In the 2-stroke engine, the same two strokes are continuously repeated with each cycle corresponding to two linear movements of the piston and one full revolution of the crankshaft. In contrast, the 4-stroke engine includes the use of two distinct pairs of strokes with respect to each full cycle thereof, hence the piston undergoes four linear movements while the crankshaft undergoes two full revolutions with respect to each full cycle. The different stroke patterns result in each of the described piston engines having unique advantages and disadvantages; hence the 2-stroke and 4-stroke engines are often utilized with respect to different applications in accordance with these differences.

A 2-stroke engine provides an advantage in that such engines fire once every revolution of the crankshaft rather than every other revolution as is the case in 4-stroke engines, thereby giving 2-stroke engines a power boost over 4-stroke engines. Such 2-stroke engines can also be formed in the absence of valves for controlling the intake of the fuel mixture and the exhaust following combustion, thereby simplifying a construction of the 2-stroke engine. Instead, the reciprocating motion of the piston is used to draw in the intake through one port while the exhaust is forced out by the incoming and higher pressure intake through another port. However, the disadvantages associated with the 2-stroke engine also generally relate to the manner in which the intake is able to mix with the exhaust during the completion of each cycle due to the manner in which the intake forces out the exhaust. Additionally, oil usage is increased as the oil must be introduced into the intake to maintain proper lubrication. This mixing of the fresh air, fuel, and oil with the outgoing exhaust decreases specific output, hurts fuel economy and flexibility, consumes higher quantities of the oil, and greatly increases the undesired emissions of the 2-stroke engine in comparison to the 4-stroke engine.

Based on these factors, it should be possible to greatly reduce oil consumption and the corresponding emissions associated with the use of piston ports by using conventional poppet valves as are typically utilized in 4-stroke engines in order to separate the intake and exhaust events.

In the ordinary 4-stroke engine the following sequence of stroke events occur with respect to each full cycle: intake stroke, compression stroke, power stroke, and exhaust stroke. Of these four events, only the compression stroke can be eliminated by performing the necessary compression externally. The introduction of external compression of the intake gas requires the use of additional components outside of the scope of the ordinary 4-stroke engine. Such an engine utilizing the external compression mechanism is referred to hereinafter as an external compression engine (ECE).

The ECE is capable of utilizing only two strokes with respect to each completed cycle, but is not considered to be the previously described 2-stroke engine. This distinction is present because the 2-stroke engine still utilizes a full compression stroke wherein the associated piston is used to compress the intake gas prior to combustion thereof, whereas the ECE omits the compression stroke entirely. The ECE also includes the separation of the intake and exhaust events, as opposed to the intake and the exhaust events occurring substantially simultaneously during a relatively short period near bottom dead center (BDC) of the associated piston.

FIG. 1 is a diagram showing crankshaft position vs. cycle event with respect to an exemplary full cycle of an ECE of the present invention. The power stroke occupies about half of the full cycle while the exhaust and intake events are considerably shortened to each occupy only about a quarter of the full cycle. The intake event in particular is quite short in comparison to the 2-stroke engine. This is possible because the intake gas is not being suctioned into the expanding volume of the piston cylinder, but is instead being pushed into the piston cylinder via the increased pressure of the intake gas as caused by the external compression thereof.

FIG. 2 shows a simple configuration of an ECE system 20 including a fixed gearbox 21 for mechanically linking a compressor 22 with an ECE 23. The compressor 22 may be a piston compressor with the resulting ECE system 20 being representative of a (so-called) Tour Engine of the prior art. A throttle valve 24 controls a flow of the intake gas from an intake 25 to the compressor 22. The intake gas compressed by the compressor 22 is then supplied to a piston cylinder of the ECE 23 to eliminate the compression stroke of the traditional ICE, as described above. However, the relationship established by the fixed gearbox 21 is disadvantageous because the compression of the intake gas within the compressor 22 and the power stroke of the ECE 23 are linked such that the flexibility and full advantages of the ECE system 20 cannot be fully appreciated. Only the throttle valve 24 controls the volume of the intake gas to the compressor 22, but the amount of compression of the intake gas cannot subsequently be controlled independently of the rate at which the ECE 23 performs each cycle due to the mechanical coupling of the compressor 22 to the ECE 23 via the fixed gearbox 21.

There is accordingly a need for an ECE system that is configured to separate the intake and exhaust events thereof, utilizes only two strokes per combustion cycle, and provides flexibility in independently controlling the compression of the intake gas and the eventual combustion of the air-fuel mixture within a piston cylinder of the combustion chamber of the ECE.

It is not uncommon for add-on devices, such as a turbocharger or a supercharger, to be added to an ICE, wherein these add-on devices can increase the mass of intake gas available to the corresponding internal combustion engine by increasing the pressure of the intake gas upstream of the ICE via compression of the intake gas. However, because an ICE typically operates at an extremely high temperature, the compression of the intake gas can disadvantageously overheat the ICE due to the manner in which such compression increases the temperature of the intake gas. Additionally, it is beneficial to further cool the higher-pressure intake gas prior to introduction into the ICE in order to increase the density of the intake gas at approximately the same pressure value.

To account for this high temperature intake gas, many superchargers or turbochargers operate with an intercooler used to cool the intake gas following the additional compression described above. For example, FIG. 3 illustrates an exemplary turbocharged or supercharged ICE system 30 having an intake 31, a compressor 32, an intercooler 33, and an ICE 34. The intercooler 33 as shown cools the intake gas compressed within the compressor 32 prior to introduction into the ICE 34, hence any heat generated by the compression performed within the ICE 34 is not subject to the cooling effect of the intercooler 33. Instead, only the compression occurring within the compressor 32 is accounted for by the cooling effect of the intercooler 33.

An ECE system may include a compressor for compressing the intake gases prior to introduction into the ECE with a flow rate of the intake gases being adjustable based on the demands of the ECE system. For example, a throttle valve may be utilized to control the flow rate of the intake gases exiting the compressor or the compressor may be operated at a different operating speed or condition. The use of such flow control means may result in the intake gases having a lower than desirable pressure and temperature when the demands of the ECE system are low, such as during idling of a vehicle utilizing the ECE system. Such a circumstance may occur when the ECE system is operating at a lower than desirable temperature, such as during a start-up process thereof, or when the ECE system is exposed to especially cold temperatures, such as when cold ambient air in utilized as an intake gas. The use of an intercooler may undesirably lead to an overcooling of the intake gases when such flow control means are utilized, which may undesirably affect operation of the ECE system.

It would accordingly also be desirable to produce an ECE system that includes the benefits of the use of an intercooler while also preventing an incidence of overcooling of the intake gas delivered to the ECE of the ECE system.

### SUMMARY OF THE INVENTION

Consistent and consonant with the present invention, an improved ECE system has surprisingly been discovered.

According to an embodiment of the invention, an external compression engine system comprises an external compression engine configured to operate without a compression stroke within a combustion chamber thereof and at least one source of pressurized intake gas. Each of the at least one sources of pressurized intake gas is configured to be placed in selective fluid communication with the combustion chamber of the external compression engine.

In some embodiments, the at least one source of pressurized intake gas is a first compressor, an intercooler is disposed downstream of the first compressor with respect to a flow of the pressurized intake gas, and a bypass flow path is configured to selectively bypass the intercooler with respect to the flow of the pressurized intake gas.

In some embodiments, the at least one source of pressurized intake gas is a first compressor, and the external compression engine does not have a fixed mechanical relationship with the first compressor. The external compression engine may be configured to drive a generator, and power generated within the generator may be transferred to an electrical motor configured to drive the first compressor. Alternatively, a mechanical continuously variable transmission mechanically may couple the first compressor to the external compression engine.

In some embodiments, the at least one source of pressurized intake gas includes a first compressor and a storage tank, wherein the combustion chamber of the external compression engine is selectively placed in fluid communication with one of the first compressor or the storage tank. The external compression engine system may further include a second compressor configured to supply pressurized intake gas to the storage tank. The external compression engine system may be configured such that placing the combustion chamber of the external compression engine in fluid communication with the storage tank results in a power boost to the external compression engine.

In some embodiment, the at least one source of pressurized intake gas is a liquid oxygen storage tank configured to store a quantity of liquid oxygen, and the external compression engine system further comprises at least one heat exchanger disposed between the liquid oxygen storage tank and the external compression engine, wherein each of the at least one heat exchangers is configured to heat the liquid oxygen to vaporize the liquid oxygen prior to entry into the external compression engine. The at least one heat exchanger may be in heat exchange relationship with a coolant used to cool the external compression engine. The the at least one heat exchanger may be in heat exchange relationship with exhaust gases exiting the external compression engine. A valve may control the flow of the exhaust gases through the at least one heat exchanger.

According to another embodiment of the invention, an external compression engine configured to operate in the absence of a compression stroke comprises an engine housing having a piston cylinder formed therein with the piston cylinder extending axially from a first end to a second end, a piston reciprocatingly disposed within the piston cylinder, at least one intake valve disposed in the engine housing adjacent the first end of the piston cylinder with each of the at least one intake valves selectively allowing for intake gases to enter the piston cylinder, and at least one exhaust port formed in the engine housing adjacent the second end of the piston cylinder with each of the at least one exhaust ports selectively allowing for exhaust gases formed within the piston cylinder to exit the piston cylinder based on an axial position of the piston within the piston cylinder.

In some embodiments, each of the intake valves includes a poppet valve disposed within an intake passageway. Each of the exhaust passageways may be formed in a circumferential side surface of the piston cylinder. An exhaust stroke of the piston may occur symmetrically relative to a bottom dead center position of the piston within the piston cylinder.

According to yet another embodiment of the present invention, an external compression engine system comprises at least one source of pressurized intake gas, a first external compression engine in selective fluid communication with each of the at least one sources of pressurized intake gas, a second external compression engine in selective fluid communication with each of the at least one sources of pressurized intake gas, and a first propeller shaft selectively mechanically coupled to one or both of the first external compression engine and the second external compression engine.

In some embodiments, a manifold conduit fluidly couples each of the at least one sources of pressurized intake gas to the first external compression engine and the second external compression. The at least one source of pressurized intake gas may include a plurality of the sources of pressurized intake gas. The system may further comprise a second propeller shaft, wherein the first propeller shaft is selectively mechanically coupled to the first external compression engine and the second propeller shaft is selectively mechanically coupled to the second external compression engine.

### BRIEF DESCRIPTION OF THE DRAWINGS

The above-mentioned, and other features and objects of the inventions, and the manner of attaining them will become more apparent and the invention itself will be better understood by reference to the following description of an embodiment of the invention taken in conjunction with the accompanying drawings, wherein:

FIG. 1 is a schematic diagram of an exemplary cycle of an external compression engine of the present invention showing crankshaft position vs. cycle event;

FIG. 2 is a schematic illustration of an exemplary external compression engine system of the prior art having a mechanically linked compressor and engine;

FIG. 3 is a schematic illustration of an exemplary internal combustion engine of the prior art having an intercooler;

FIG. 4 shows an external compression engine system according to a first embodiment of the present invention, wherein a bypass flow path is configured to bypass an intercooler;

FIG. 5 shows an external compression engine system according to a second embodiment of the present invention, wherein an electrical system is utilized to power a compressor in the absence of a mechanical coupling between the compressor and an external compression engine;

FIG. 6 shows an external compression engine system according to a third embodiment of the present invention, wherein a mechanical continuously variable transmission is utilized to transfer power from an external compression engine to a compressor;

FIG. 7 shows an external compression engine system according to a fourth embodiment of the present invention, wherein the external compression engine system is operating in a first mode of operation wherein a main compressor is placed in fluid communication with an external compression engine;

FIG. 8 shows the external compression engine system according to FIG. 7 when the external compression engine system is operating in a second mode of operation wherein a pressurized storage tank is placed in fluid communication with the external compression engine;

FIG. 9 shows an external compression engine system according to a fifth embodiment of the present invention, wherein the external compression engine system is operating in a first mode of operation wherein exhaust gases are not utilized to heat a fluid to be compressed within a compressor;

FIG. 10 shows the external compression engine system of FIG. 9 when operating in a second mode of operation wherein exhaust gases are utilized in heating the fluid to be compressed within the compressor;

FIG. 11 graphically illustrates the flexibility of an external compression engine system to operate using any number or combination of power sources, any number or combination of compressors and/or pressurized fluid tanks, and any number and combination of external compression engines;

FIG. 12 shows an external compression engine system having multiple external compression engines and multiple output components according to another embodiment of the present invention;

FIG. 13 is an elevational cross-sectional view of an external compression engine having a uniflow engine flow configuration according to an embodiment of the present invention, wherein FIG. 13 illustrates an intake stroke of the external compression engine;

FIG. 14 illustrates the external compression engine of FIG. 13 when a piston thereof is at top dead center during a power stroke of the external compression engine;

FIG. 15 is a schematic diagram showing a position of a crankshaft of the external compression engine with respect to each of the strokes illustrated in FIGS. 13 and 14;

FIG. 16 illustrates the external compression engine of FIG. 13 when the piston thereof is moving downwardly towards bottom dead center during the power stroke of the external compression engine;

FIG. 17 illustrates the external compression engine of FIG. 13 when the piston thereof is moving downwardly towards bottom dead center thereof while uncovering a plurality of exhaust ports during an overlapped portion of the power stroke and an exhaust stroke of the external compression engine;

FIG. 18 is a schematic diagram showing a position of a crankshaft of the external compression engine with respect to each of the strokes illustrated in FIGS. 16 and 17;

FIG. 19 illustrates the external compression engine of FIG. 13 when the piston thereof is at bottom dead center with each of the exhaust ports fully opened during the exhaust stroke of the external compression engine;

FIG. 20 illustrates the external compression engine of FIG. 13 when the piston thereof is moving upwardly towards top dead center thereof while progressively covering the plurality of the exhaust ports during an overlapped portion of the exhaust stroke and the intake stroke of the external compression engine; and

FIG. 21 is a schematic diagram showing a position of a crankshaft of the external compression engine with respect to each of the strokes illustrated in FIGS. 19 and 20.

### DETAILED DESCRIPTION OF AN EMBODIMENT

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Various different external compression engine (ECE) systems are disclosed herein according to different embodiments of the present invention. Each of the ECE systems includes an internal combustion chamber for carrying out combustion of an intake gas and fuel mixture with an associated piston reciprocatingly disposed within the internal combustion chamber, at least one externally located source of pressurized intake gas configured for selective fluid communication with the internal combustion chamber of the external compression engine externally, and the related components configured to control a flow of the intake gas prior to entry into the internal combustion chamber, and in some circumstances the exhaust gas exiting the internal combustion chamber. The intake gas is generally understood to be (ambient) air, but alternative fluids may be utilized as described hereinafter so long as the combustion event is able to occur within the internal combustion chamber of the ECE in the absence of a compression stroke performed by the ECE. As used hereinafter, the term ECE generally refers to the structure defining the internal combustion chamber and associated reciprocating piston. Accordingly, each reference to an ECE refers to the components of the associated ECE system wherein combustion occurs with respect to a mixture of a fuel and a previously compressed intake gas for generating power to be delivered to an associated crankshaft. The term compressor generally refers to any of the compression mechanisms associated with and disposed upstream of the corresponding ECE. Each ECE system accordingly includes the combination of the ECE and at least one compressor and/or source of previously compressed intake gas.

It is generally assumed that each of the ECE systems shown and described herein include the introduction/injection of a fuel to the intake gas at a position within the corresponding ECE or at a position immediately upstream of the corresponding ECE. Specifically, the fuel may be added to the previously compressed intake gas within the internal combustion chamber of the ECE or within a flow space upstream of and in fluid communication with the internal combustion chamber. However, the present invention is not necessarily limited to such a configuration, as it is conceivable that some applications may allow for the introduction of the fuel at a position upstream of those contemplated above. The present invention is accordingly inclusive of embodiments wherein an intake gas and fuel mixture is present at any position described hereinafter as including only the intake gas, as applicable.

Several of the embodiments of the ECE systems are described hereinafter with respect to a specific type of compressor that may be well suited to the particular application, but one skilled in the art will appreciate that any of a variety of suitable compressor types may be substituted for the described compressors without necessarily departing from the scope of the present invention. As such, each disclosed embodiment of one of the ECE systems should be considered as inclusive of any type of suitable compressor even when not explicitly indicated as such, unless noted otherwise. The possible types of compressor suitable for use with the disclosed ECE systems may include piston, centrifugal, axial, multi-stage roots, and scroll, as non-limiting examples.

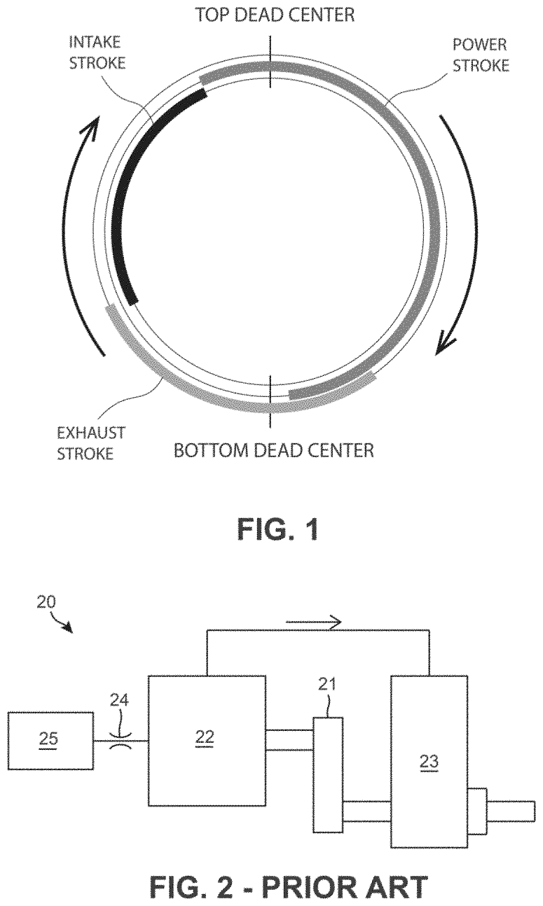

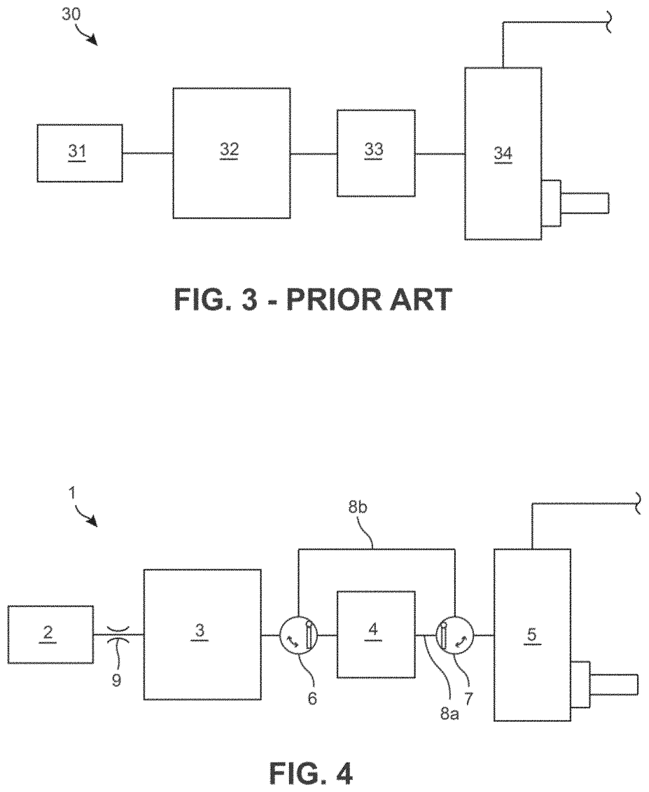

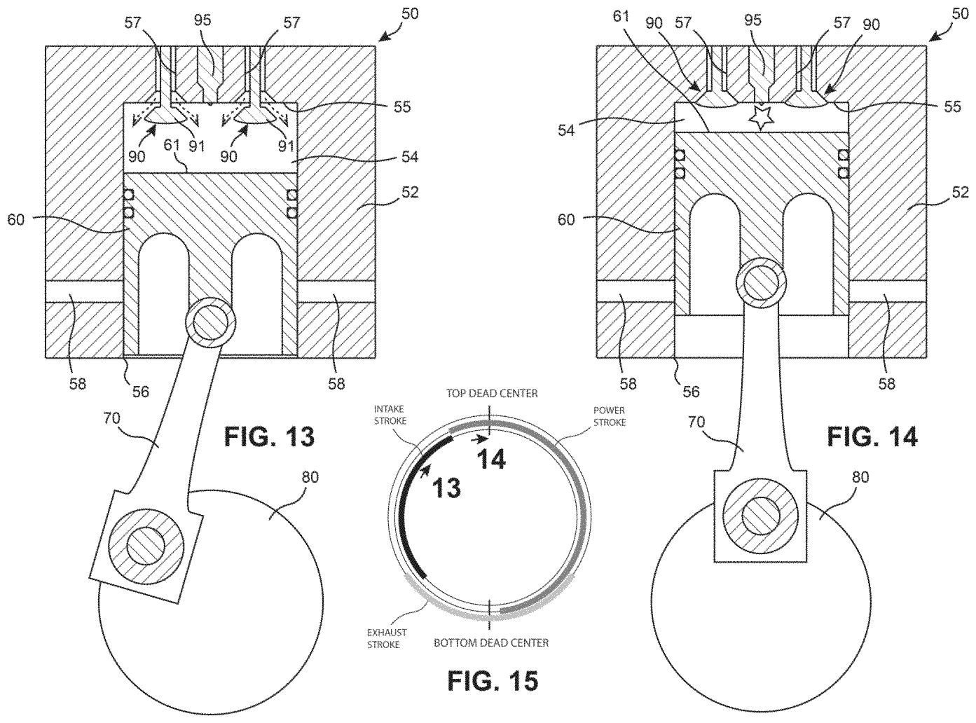

Each of the ECE systems disclosed herein may utilize a stroke cycle similar to that shown in FIG. 1 hereof. However, as explained herein with reference to FIGS. 13-21, alternative stroke cycles may be utilized depending on the intake configuration and the exhaust configuration of the corresponding ECE. However, in all cases, the ECE does not utilize a compression stroke wherein an associated piston is primarily responsible for the compression of the intake gas and fuel mixture prior to combustion thereof.

Traditionally, the phrase “high-compression ratio” as used with respect to an internal combustion engine having a compression stroke also corresponds to a corresponding “high-expansion ratio,” wherein a numerically large expansion ratio increases the amount of work extracted from the combustion of the air-fuel mixture, thereby increasing power output and fuel economy. However, because each of the ECE systems disclosed herein utilizes an external compressor in the absence of a compression stroke within the ECE, the term “compression ratio” as used hereinafter instead refers to the degree of compression performed within the external compressor of each disclosed ECE system. As such, the compression ratio of each of the ECE systems is not linked to the expansion ratio of the ECE of that same system.

The ECE systems disclosed hereinafter are described as operating in a manner wherein certain components thereof are described as being selectively activated, adjusted, switched, or the like. Unless noted otherwise, it should be assumed that all such actions occur as a result of a signal generated by a controller or the like associated with the described ECE system. That is, each of the components of each of the ECE systems described as being selectively or otherwise actively controlled in some manner may be assumed to be in signal communication with a controller configured to generate signals for causing such actions to take place when certain conditions are met or when an operator of the system desires a certain outcome. For example, references to valves being switched (in a non-passive manner) in reaction to a certain condition being sensed or a certain selection being made by an operator may be assumed to be switched as a result of a signal originating from such a controller. In contrast, components that are passively controlled as a result of certain conditions being met within the corresponding ECE system are described as such herein and should be assumed to not be actively controlled by such a controller in such circumstances. For example, a check valve or the like may not be in signal communication with such a controller.

Such a controller may be responsible for the operation of components such as the compressors, valves, and mechanical power transfer mechanisms of the described ECE systems, as non-limiting examples. Certain embodiments may also be described as including certain processes that occur in reaction to a certain condition being met with respect to one or more components of the corresponding ECE system. It may be assumed that, unless described as being communicated by other means, such conditions are sensed by a corresponding sensor that is in signal communication with the controller for providing the controller the information necessary to make the determinations leading to the activation or adjustment of the components of the corresponding ECE system.

FIG. 4 illustrates an ECE system 1 according to a first embodiment of the present invention. The ECE system 1 includes an intake 2, a compressor 3, an intercooler 4, and an ECE 5. The compressor 3 forms a source of pressurized intake gas configured for selective fluid communication with a combustion chamber of the ECE 5. The compressor 3 is arranged downstream of the intake 2 with respect to a flow of intake gas entering the ECE system 1 via the intake 2. The ECE system 1 may optionally include a throttle valve 9 disposed downstream of the intake 2 and upstream of the compressor 3, wherein the throttle valve 9 is configured to control a flow of the intake gas entering the compressor 3. Alternatively, the ECE system 1 may be provided in the absence of the throttle valve 9, wherein the compressor 3 is configured to be variably operable for altering the flow rate and/or pressure of the intake gas exiting the compressor 3 and flowing towards the ECE 5. All compression of the intake gas takes place in the compressor 3 due to the lack of a compression stroke within the ECE 5.

The intercooler 4 may be any type of heat exchanger and may be in heat exchange communication and fluid communication with any secondary fluid for exchanging heat with the intake gas passing through the ECE system 1. The secondary fluid is selected to be at a low enough temperature when passing over the intercooler 4 such that the intake gas is cooled by transferring heat to the secondary fluid. The secondary fluid may be air, a coolant, or the like. The secondary fluid may originate from another system of a vehicle or other device utilizing the ECE system 1, as desired.

The ECE system 1 branches downstream of the compressor 3 to include each of an intercooler flow path 8a and a bypass flow path 8b. The intercooler flow path 8a includes the intercooler 4 while the bypass flow path 8b bypasses the intake gas around the intercooler 4 when flowing towards the ECE 5 such that the previously compressed intake gas is not further cooled within the intercooler 4. In the illustrated embodiment, each of the intercooler flow path 8a and the bypass flow path 8b extend from a branch point formed by a first switching valve 6 to a re-entry point formed by a second switching valve 7. The first switching valve 6 is disposed downstream of the compressor 3 and upstream of the intercooler 4 and the second switching valve 7 is disposed downstream of the intercooler 4 with respect to the intercooler flow path 8a and upstream of the ECE 5.

Each of the switching valves 6, 7 is adjustable between a first position and a second position, wherein the first position of each of the valves 6, 7 corresponds to the intake gases flowing through the intercooler flow path 8a and the corresponding intercooler 4 while the second position (shown in FIG. 4) of each of the valves 6, 7 corresponds to the intake gas bypassing the intercooler 4 by flowing through the bypass flow path 8b. The illustrated switching valves 6, 7 may be replaced with any valve configuration allowing for the selective flow of the intake gas through or around the intercooler 4 via one of the intercooler flow path 8a or the bypass flow path 8b. For example, each valve 6, 7 may be replaced with a suitable three-way valve, or each valve 6, 7 may be replaced with multiple valves disposed upstream and/or downstream of each of the branch point and the re-entry point. Additionally, one of the two valves 6, 7 may be removed from the ECE system 1 while the other of the valves 6, 7 remains while still allowing for the same general flow configuration, although the intercooler 4 may not be entirely isolated from the intake gas absent the use of valves at positions both upstream and downstream of the intercooler 4. Substantially any valve assembly or configuration wherein the intercooler 4 may be selectively passed by the intake gas for cooling the intake gas or selectively bypassed by the intake gas may be utilized while remaining within the scope of the present invention.

The use of the compressor 3 to exclusively compress the intake gas renders it possible to overcool the intake gas under certain circumstances. Optimum use of an intercooler 4 within the ECE system 1 therefore requires a balancing of the desire to have a very dense, very cold intake charge to allow for impressive power outputs against the fact that the overall thermal efficiency of the system may drop dramatically at partial throttle (when the need for the intercooler 4 is greatly reduced).

The ECE system 1 may include any necessary sensors therein for determining a temperature and/or pressure of the intake gas at any position along the ECE system 1. Such information may be utilized to determine whether or not to place the valves 6, 7 in the first position (normal operating demands) or the second position (low operating demands at partial throttle) according to the balancing of factors mentioned above.

For example, a temperature sensor and/or a pressure sensor may be disposed at a position downstream of the compressor 3 and upstream of the branch point formed by the first switching valve 6 for determining a temperature and/or a pressure of the intake gas upstream of the branching of the ECE system 1 into the intercooler flow path 8a and the bypass flow path 8b. Alternatively, the temperature sensor and/or pressure sensor may be disposed at a position downstream of the intercooler 4 and upstream of the ECE 5. Utilizing either configuration, a control scheme of the ECE system 1 may include the valves 6, 7 adjusted to the first position during periods of time when the temperature and/or pressure of the intake gas is indicative of the intercooler 4 providing advantageous cooling of the intake gas for a power boost to the ECE system 1. The control scheme may further include the valves 6, 7 adjusted to the second position during period of time when the temperature and/or pressure of the intake gas is indicative of the intercooler 4 providing an undesired overcooling of the intake gas in a manner negatively affecting the thermal efficiency of the ECE system 1. For example, a detected temperature of the intake gas falling below a threshold value at any one or greater of the specified positions may facilitate the switching of the valves 6, 7 from the first position to the second position, thereby avoiding the overcooling of the intake gas. Additional sensors may be utilized to monitor other conditions such as the temperature of the secondary fluid used to cool the intake gas or the temperature of the components forming the ECE 5 in order to determine the information necessary to determine whether the ECE system 1 is operating efficiently. It should be understood that alternative or additional control schemes may be utilized so long as the resulting configuration leads to a bypassing of an intercooler for the purpose of preventing an overcooling of the previously compressed intake gas passing therethrough.

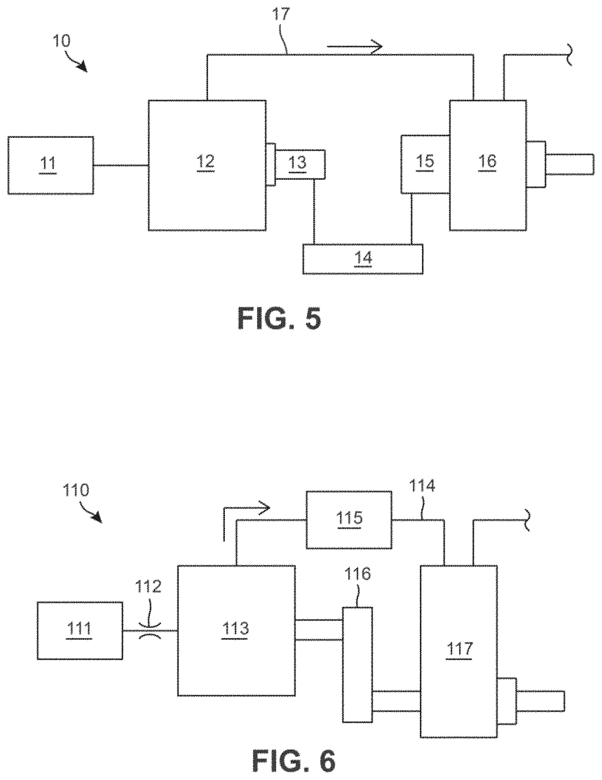

FIG. 5 illustrates an ECE system 10 according to an embodiment of the present invention. The ECE system 10 includes an intake 11, a compressor 12, a motor 13, an electrical system 14, a generator 15, an ECE 16, and a fluid line 17. The intake 11 leads to the compressor 12, which may be a scroll compressor. The compressor 12 forms a source of pressurized intake gas configured for selective fluid communication with a combustion chamber of the ECE 16. The speed of the compressor 12, and hence the rate at which the compressor 12 outputs the compressed intake gas, is controlled by the motor 13. The motor 13 is an electrical motor and is electrically coupled to the electrical system 14. The fluid line 17 communicates the compressed intake gas exiting the compressor 12 to the inlet side of the ECE 16. The fluid line 17 may be representative of any pipe, conduit, flow channel, or the like for communicating a fluid therethrough. In some embodiments, the fluid line 17 may be representative of a direct connection between an outlet of the compressor 12 and an inlet of the ECE 16. In other embodiments, the ECE system 10 may include an intercooler bypass configuration such as is disclosed with respect to the ECE system 1 of FIG. 4. That is, the configuration of the ECE system 10 between the compressor 12 and the ECE 16 may be the same as the configuration of the ECE system 1 between the compressor 3 and the ECE 5, wherein a valve arrangement selectively controls a flow of intake gas between an intercooler flow path and a bypass flow path. The ECE 16 combusts the intake gas and fuel mixture and transfers this energy to rotational motion, which is in turn transferred to the generator 15. The generator 15 is configured to power the electrical system 14, which is in turn configured to power the motor 13.

The ECE system 10 is thus formed without a mechanical connection such as a fixed gearbox between the motor 13 and the generator 15. This allows for the compressor 12 to be operated at a desired speed/configuration (depending on the type of compressor) for prescribing a desired flow rate of the intake gas through the ECE system 10 without having to account for the instantaneous mechanical configuration or condition of the ECE 16 during operation thereof. The ECE system 10 accordingly operates without the need of a throttle valve for prescribing the flow of the intake gas into the compressor 12, which provides large efficiency gains. The compression ratio of the compressor 12, as defined above with respect to an external compressor, can thus be made low enough to allow the ECE system 10 to operate efficiently via the use of what are generally considered low-quality fuels, such as jet fuel, without the risk of knocking.

FIG. 6 illustrates another ECE system 110 according to another embodiment of the present invention. The ECE system 110 includes an intake 111, a throttle valve 112, a compressor 113, a fluid line 114 having an intercooler 115 disposed thereon, a mechanical continuously variable transmission (CVT) 116, and an ECE 117. The intake 111 leads to the throttle valve 112, which is adjustable to control a flow rate of the intake gas to the compressor 113. The compressor 113 may be a multi-stage roots compressor, but alternative compressor types may be utilized without departing from the scope of the present invention. The compressor 113 forms a source of pressurized intake gas configured for selective fluid communication with a combustion chamber of the ECE 117.

The mechanical CVT 116 is configured to control and adjust a transmission of the power generated by the ECE 117 to the compressor 113, thereby allowing for a drive mechanism (shaft) of the compressor 113 to rotate at a different speed from the crankshaft of the ECE 117. The mechanical CVT 116 accordingly prevents a mechanically fixed relationship between the operating rate of the ECE 117 and the compressor 113 as would be the case if a fixed gearbox were utilized. An operating speed of the compressor 113 may accordingly be controlled independently of an instantaneous operating speed of the ECE 117.

The intercooler 115 is configured to cool the intake gas prior to entry into the ECE 117 in order to increase the density of the intake gas, which increases the power generated by the ECE 117 while also preventing an incidence of overheating of the ECE 117. The compressed intake gas may be cooled by ambient air, a coolant associated with operation of a vehicle or the like having the ECE system 110 installed therein, or any other fluid able to be routed into heat exchange relationship with the intake gases via the structure of the intercooler 115. Although not pictured in FIG. 6, the fluid line 114 having the intercooler 115 may be replaced with the configuration of the ECE system 1 intermediate the compressor 3 and the ECE 5 such that the intake gas may be passed through the intercooler 115 or bypassed through a bypass flow path depending on a configuration of an associated valve assembly.

The combined use of the throttle valve 112 and the mechanical CVT 116 advantageously allows for an instant power reduction via control of the rate of flow of the intake gas under circumstances wherein the mechanical CVT 116 lags behind due to delays in a “gearing down” of the mechanical CVT 116, thereby increasing the responsiveness of the ECE system 110.

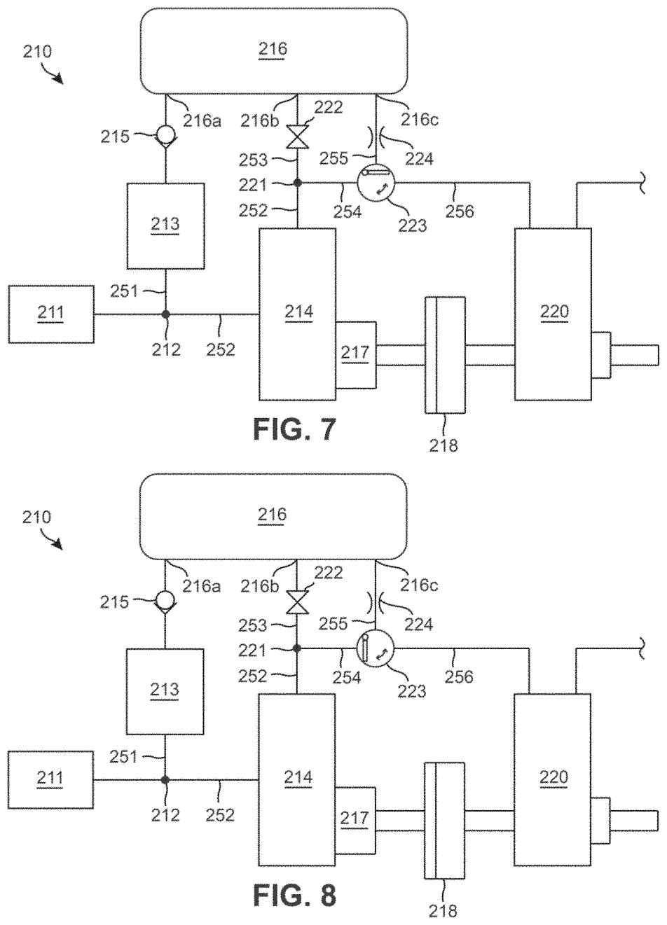

Referring now to FIG. 7, an ECE system 210 having what is hereinafter referred to as power boosting using stored energy (PBSE) mode of operation is disclosed, wherein the PBSE mode of operation is substantially similar in effect to the known methods of turbocharging or supercharging an intake gas associated with a traditional ICE as explained in the background of the present invention.

The ECE system 210 includes an intake 211 leading to a first branch point 212. The first branch point 212 allows for the intake gas originating from the intake 211 to flow towards each of an auxiliary compressor 213 and a main compressor 214. Specifically, the first branch point 212 divides the flow of the intake gas encountering the first branch point 212 into a first partial flow towards the auxiliary compressor 213 and a second partial flow towards the main compressor 214. A first fluid line 251 may extend from the first branch point 212 towards the auxiliary compressor 213 and a second fluid line 252 may extend from the first branch point 212 towards the main compressor 214. The auxiliary compressor 213 and the main compressor 214 may each be described as being disposed downstream of the first branch point 212 with respect to a direction of flow of the intake gas encountering the first branch point 212. The auxiliary compressor 213 and the main compressor 214 may each be said to independently represent a source of pressurized intake gas configured for selective fluid communication with a combustion chamber of an associated ECE 220.

A one-way check valve 215 is disposed downstream of the auxiliary compressor 213 with respect to the flow of the intake gas through the first fluid line. The check valve 215 controls the flow of the intake gas into a high-pressure storage tank 216 disposed downstream of the auxiliary compressor 213 with respect to the first fluid line conveying the first partial flow of the intake gas. Specifically, the check valve 215 only opens when the auxiliary compressor 213 is operated to increase the pressure of the intake gas above the bias of the check valve 215 and the pressure of the gas within the storage tank 216. The first fluid line 251 leads to a first inlet 216a into the storage tank 216 at a position downstream of the check valve 215. The storage tank 216 forms a source of pressurized intake gas configured for selective fluid communication with a combustion chamber of the ECE 220.

The auxiliary compressor 213 may be driven electrically or directly from the power generated by the ECE system 210, as desired. Specifically, the auxiliary compressor 213 may be powered directly or indirectly via a crankshaft of the associated ECE 220. The auxiliary compressor 213 may be configured to be operable independently of the main compressor 214. The storage tank 216 may be relatively small and rated at 3000 psi. However, the storage tank 216 is not necessarily limited to any size or pressure rating, and alternative storage tanks may be utilized in the ECE system 210 while remaining within the scope of the present invention. The auxiliary compressor 213 may be provided to be relatively small such that it takes about 30 minutes to recharge the storage tank 216. However, the auxiliary compressor 213 may be provided at any size for recharging the storage tank 216 in any given time period while remaining within the scope of the present invention. The auxiliary compressor 213 may be configured to operate continuously until the storage tank 216 reaches the desired tank pressure, at which point the auxiliary compressor 213 shuts off. The sizing of each of the described components may be based on the PBSE mode duty cycle, wherein it is assumed that the full boost pressure will only be needed for a period of one minute or less per hour of vehicle operation.

The main compressor 214 may be operatively coupled to a variable speed compressor drive 217. A clutch 218 may be configured to selectively engage or disengage the main compressor 214 from being mechanically coupled to and driven by the ECE 220. However, the main compressor 214 may be driven by alternative means without necessarily departing from the scope of the present invention, as the benefits of the use of the storage tank 216 may be realized independently of the benefits of utilizing the power provided by the ECE 220 in powering the main compressor 214. Alternative mechanisms may also be utilized in transferring the power generated by the ECE 220 to the main compressor 214 in addition to the use of the variable speed compressor drive 217 and the clutch 218.

A second branch point 221 is disposed downstream of the main compressor 214. The second branch point 221 is accordingly positioned to receive the second partial flow of the intake gas after passing through the main compressor 214, wherein the intake gas may be selectively compressed within the main compressor 214 to increase a pressure of the intake gas before encountering the second branch point 221. The second branch point 221 is configured to divide the intake gas comprising the second partial flow into a third partial flow towards the storage tank 216 along a third fluid line 253 and a fourth partial flow towards a switching valve 223 along a fourth fluid line 254. The storage tank 216 and the switching valve 223 may each be described as being disposed downstream of the second branch point 221 with respect to the second partial flow of the intake gas encountering the second branch point 221, which also includes each of the storage tank 216 and the switching valve 223 being disposed downstream of the main compressor 214 with respect to the second partial flow of the intake gas.

The third fluid line 253 further includes a valve 222 disposed between the main compressor 214 and the storage tank 216, and more specifically between the second branch point 221 and a second inlet 216b into the storage tank 216. The valve 222 is configured to selectively allow or disallow the flow of the compressed intake gas exiting the main compressor 214 to flow into and pressurize the storage tank 216.

The switching valve 223 disposed along the fourth fluid line 254 forms a first entry point of the ECE system 210 disposed downstream of the second branch point 221 with respect to the second partial flow of the intake gas passing through the main compressor 214. A fifth fluid line 255 extends between an outlet 216c of the storage tank 216 and the switching valve 223 and includes a throttle valve 224. A second flow path extends from the switching valve 223 to an inlet side of the ECE 220. The switching valve 223 is configured to selectively switch which of the storage tank 216 or the main compressor 214 is placed in instantaneous fluid communication with the ECE 220. The switching valve 223 may be provided as a flap valve or any suitable three-way valve capable of accomplishing the flow configurations described herein. The throttle valve 224 is configured to control a flow rate of the pressurized intake gas exiting the storage tank 216 via the outlet 216c and flowing towards the ECE 220 when the switching valve 223 is positioned to allow for flow therebetween.

The described fluid lines 251, 252, 253, 254, 255, 256 may be representative of any pipes, hoses, conduits, or other flow conveying channels while remaining within the scope of the present invention, as desired. It should also be understood that any of the fluid lines 251, 252, 253, 254, 255, 256 may be replaced with a direct connection between the adjacent components forming the ECE system 210 while remaining within the scope of the present invention, so long as the same flow configurations and beneficial relationships are maintained as described herein. The fluid lines 251, 252, 253, 254, 255, 256 are primarily labeled as such to more clearly describe the modes of operation of the ECE system 210 with reference to FIGS. 7 and 8, wherein the given numbering of the fluid lines 251, 252, 253, 254, 255, 256 is arbitrary and does not specifically connote any prescribed flow order with respect to the intake gases through the ECE system 210 or the requirement that each and every fluid line 251, 252, 253, 254, 255, 256 be present within the ECE system 210 for achieving various aspects of the present invention. Various modifications to the ECE system 210 contemplating the elimination of certain fluid lines 251, 252, 253, 254, 255, 256 are described hereinafter, hence the assigned numbering of the fluid lines 251, 252, 253, 254, 255, 256 should not be considered absolute.

It should also be understood that additional components and/or fluid lines may be added to the ECE system 210 in addition to those shown and described herein without necessarily departing from the scope of the present invention, hence the disclosed configuration is not necessarily limiting with respect to additional features that may be incorporated into the ECE system 210. For example, an intercooler or the like may be integrated into the structure of ECE system 210 for cooling the compressed intake gases prior to entry into the ECE 220 without necessarily deviating from the advantageous features of the ECE system 210 as described hereinafter. Such an intercooler may also be associated with a bypass flow path in the same manner described hereinabove with reference to the ECE systems 1, 10, 110, which may be positioned between the switching valve 223 and the ECE 220.

A normal mode of operation of the ECE system 210, which corresponds to the ECE system 210 operating in a mode not corresponding to one of the disclosed PBSE modes of operation, is illustrated in FIG. 7. During the normal operation of the ECE system 210, the intake 211 receives ambient air and delivers at least a partial flow of the air to the main compressor 214 along the second fluid line 252. All of the ambient air may be delivered to the main compressor 214 during periods of inactivity of the auxiliary compressor 213. The switching valve 223 is adjusted to a position wherein the main compressor 214 is in fluid communication with the ECE 220 via the fourth fluid line 254, the switching valve 223, and the sixth fluid line 256. Concurrently, the position of the switching valve 223 results in the storage tank 216 not being placed in fluid communication with the ECE 220 via the fifth fluid line 255 and the throttle valve 224. The switching valve 223 is shown schematically in FIG. 7 as a flap adjusted to a position for blocking flow from the fifth fluid line 255 while allowing for flow from the fourth fluid line 254 to the sixth fluid line 256 for fluidly coupling the main compressor 214 to the ECE 220. The compressed intake gas is then able to enter the ECE 220 where the intake gas is mixed with a fuel and combusted for generating power that can be utilized in powering an associated drive system of a vehicle as well as the main compressor 214, among other components of the associated vehicle or the ECE system 210. Specifically, the clutch 218 may be engaged such that the power generated by the ECE 220 is transferred to the main compressor 214 in a selective manner for operating the main compressor 214 at a desired operating speed via the use of the variable speed compressor drive 217.

The normal mode of operation of the ECE system 210 may include the pressurization of the storage tank 216 depending on the instantaneous pressure of the intake gases within the storage tank 216. For example, the storage tank 216 may be associated with a pressure sensor (not shown) configured to detect a pressure within the storage tank 216 and communicate such a pressure value to a controller responsible for monitoring and controlling operation of the ECE system 210. The auxiliary compressor 213 may be configured to be operated only when the pressure within the storage tank 216 is detected to be below a preselected first pressure value. The auxiliary compressor 213 may be further configured to be operated continuously until the storage tank 216 is pressurized to a preselected second pressure value. In any event, the auxiliary compressor 213 is operated only when a pressurization of the storage tank 216 is required for attaining a pressure within the storage tank 216 corresponding to a pressure suitable for initiating one of the described PBSE modes of operation.

The configuration of the ECE system 210 of FIG. 7 also optionally allows for at least a portion of the compressed intake gases exiting the main compressor 214 to be delivered to the inlet 216b of the storage tank 216 via the third fluid line 253 upon an opening of the valve 222 during the normal mode of operation of the ECE system 210. As such, the storage tank 216 may be simultaneously pressurized by each of the auxiliary compressor 213 and the main compressor 214 during the normal mode of operation of the ECE system 210, depending on the instantaneous pressure within the storage tank 216 and the open or closed position of the valve 22. The illustrated valve 222 may also be supplemented by a passively activated check valve disposed along the third fluid line 253 for passively preventing a backflow of the intake gas along the third fluid line 253 during an adjustment of the valve 222 while the main compressor 214 is inactive.

In a first PBSE mode of operation, which is illustrated in FIG. 8, the throttle valve 224 opens downstream of the outlet 216c of the storage tank 216 and the switching valve 223 is adjusted to allow for the pressurized intake gas from the storage tank 216 to flow therethrough and towards the ECE 220 via the fifth fluid line 255 and the sixth fluid line 256. As should be understood, the first PBSE mode of operation is initiated following a pressurization of the storage tank 216 according to one of the methods disclosed hereinabove. The clutch 218 disengages from the main compressor 214 to prevent the main compressor 214 from continuing to compress the intake gas originating from the intake 211. The valve 222 may be closed off to prevent a backflow of intake gas from the storage tank 216, or the supplemental check valve may be passively adjusted to prevent such backflow. The disengagement of the clutch 218 from the main compressor 214 also beneficially reduces the parasitic load placed on the ECE 220 during those periods of time where operation of the compressor 214 is not required. Alternatively, although less efficient, the main compressor 214 may be continuously operated and off-loaded, as desired, during the periods of time that the intake gas is allowed to exit the storage tank 216, or the valve 222 may be opened to allow for a continuous pressurization of the storage tank 216.

The “compression work,” which refers to the work of compressing the intake gas prior to ignition within the traditional ICE, is typically a third or more of the total work produced by such an ICE. Thus, for any desired quantity of horsepower to be delivered to an output shaft by the ICE, a greater total amount of horsepower must be produced by the ICE to account for the loss to compression work when compressing the intake gas. The first PSBE mode of operation temporarily redirects 100% of the total power to the output shaft of the ECE 220 (rather than driving the main compressor 214), thereby giving a large boost in power regardless of the increase in manifold pressure due to the main compressor 214 no longer being utilized.

The high-pressure intake gas exiting the storage tank 216 via the outlet 216c can accommodate any conceivable manifold pressure target within the ECE 220, up to several hundred PSI, which is more than the vast majority of engines can withstand when used in automotive applications. Specifically, the delivered pressure is a least as high as would be expected during use of a traditional ICE engine having a compression stroke.

The throttle valve 224 is adjustable to control the output of the ECE 220 during the first PBSE mode of operation. The first PBSE mode of operation may in some circumstances only be utilized for a few seconds at a time, such as during times of heightened need during operation of a motor vehicle. For example, the first PBSE mode of operation may be utilized during a period of rapid acceleration such as when passing another vehicle or merging suddenly onto a highway. As the first PBSE mode of operation is utilized, the storage tank 216 is continually drained, hence the duration of the first PBSE mode of operation is dependent on the pressure level within the storage tank 216 prior to the initiation of the first PBSE mode of operation (and the corresponding volume of the selected storage tank 216). Following a depletion of the storage tank 216, another period of time, such as 30 minutes, may be necessary to refill the storage tank 216 for reengaging the first PBSE mode of operation. However, any period of time may be utilized in performing the refilling and pressurizing process with respect to the storage tank 216 while remaining within the scope of the present invention.

A second PBSE mode of operation with respect to the illustrated configuration of the ECE system 210 of FIG. 8 is also possible. The second PBSE mode of operation does not necessarily require use of the auxiliary compressor 213, hence the auxiliary compressor 213 and check valve 215 may be omitted from the system 210. The ECE system 210 as depicted in FIG. 8 may accordingly be modified to include the intake 211 leading directly to the main compressor 214 in the absence of a branch for delivering the intake gas towards the storage tank 216, as desired.

In the second PBSE mode of operation, the variable speed compressor drive 217 is utilized to run the main compressor 214 at a higher than necessary speed, and especially during periods of low demand. The output of the main compressor 214, which is higher than needed for ordinary operation of the ECE 220, is delivered into the storage tank 216 via the inlet 216b following an opening of the valve 222. The switching valve 223 is selectively adjusted to prevent the output from the main compressor 214 flowing directly to the ECE 220 through the fourth fluid line 254. Instead, the engine power of the ECE 220 is controlled by the throttle valve 224, which selectively delivers the pressurized intake gas disposed within the storage tank 216 to the ECE 220 via the fifth fluid line 255 and the sixth fluid line 256. The throttle valve 224 may be adjusted to provide less of the intake gas to the ECE 220 than is output from the main compressor 214, hence the storage tank 216 becomes pressurized during operation in the second PBSE mode of operation. The second PBSE mode of operation is configured to pressurize the storage tank 216 to about 300 psi, as opposed to the 3000 psi contemplated by the first PBSE mode of operation, while about 80 psi is delivered to the ECE 220. The second PBSE mode of operation limits the power output of the system 210, but does allow for the recharging of the storage tank 216 much more quickly. It should be understood that the values contemplates hereinabove regarding the required pressure values are merely representative examples and should not be seen as limiting, as any pressure values may be utilized in accordance with the instantaneous application of the ECE system 210.

The ECE system 210 may also conceivably be produced in the absence of either of the compressors 213, 214 if the storage tank 216 is pre-pressurized and provided large enough to maintain operation of the ECE 220 for long enough according to the application of the ECE system 210. However, this would not normally be a very practical solution for vehicular applications due to the short time duration of the operation of the ECE 220 as well as the need for an extremely large and heavy storage tank 216.

One solution to the problem of limited storage size when attempting to eliminate the compression of the intake gas within the associated system may be to utilize stored liquid oxygen rather than compressed ambient air. The use of liquid oxygen also allows the associated engine to operate in non-atmospheric locations, such as underwater in the form of a torpedo or in outer space in the form of a spacecraft.

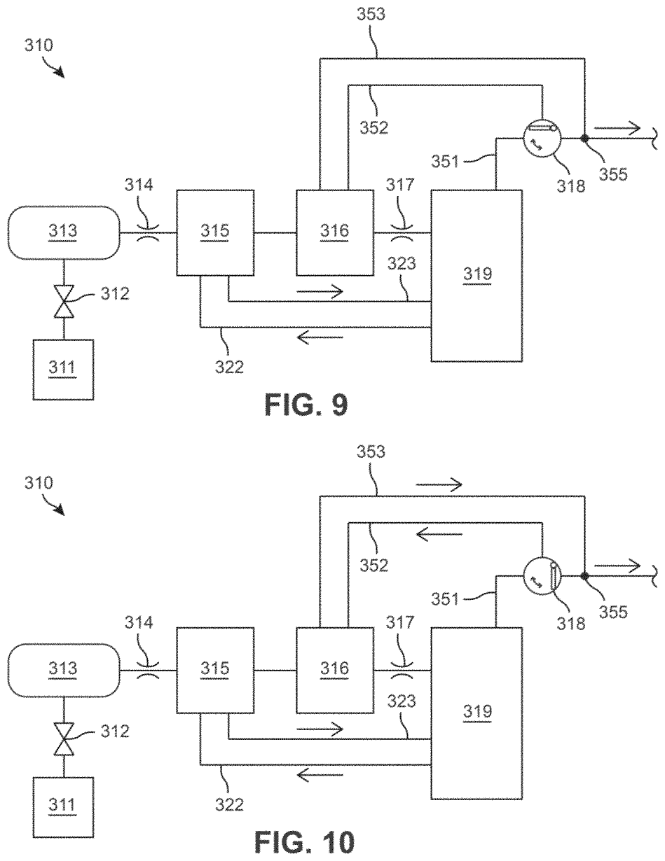

Referring now to FIGS. 9 and 10, a system 310 utilizing liquid oxygen as contemplated above is disclosed. A liquid oxygen (LOX) storage tank 313 is filled by an LOX fill port 311 and a valve 312 configured to selectively allow for a high pressure supply of LOX to enter the LOX storage tank 313. The storage tank 313 forms a source of pressurized intake gas configured for selective fluid communication with a combustion chamber of an ECE 319. The LOX fill port 311 may be associated with a pump in order to pressurize the LOX when filling the storage tank 313. A first throttle valve 314 is disposed downstream of the LOX storage tank 313 is configured to be adjustable to vary the LOX supply pressure to the downstream arranged components of the system 310. In the case of the ECE system 310 being utilized in a liquid-fueled rocket, a turbopump of the rocket may be utilized in delivering the LOX to the ECE system 310 at a desired injection pressure and flow rate. The LOX is run through a pair of heat exchangers 315, 316 arranged in series. The heat exchangers 315, 316 are configured to convert (evaporate) an appropriate amount of the LOX to high-pressure oxygen gas across a range of different flows.

The heat exchanger 315 is in fluid and heat exchange relationship with an engine coolant circulated through the ECE 319 for cooling the ECE 319 during operation thereof. The heat exchanger 315 and the ECE 319 are fluidly coupled by fluid lines 322, 323 through which the coolant may circulate. The fluid lines 322, 323 may be representative of any pipes, hoses, conduits, flow channels, or the like, as desired, and may be circulated by the coolant in either possible flow direction. The fluid lines 322, 323 may comprise a portion of a larger coolant system configured to cool and/or heat various other components of the associated vehicle or device, and may be in fluid communication with a pump utilized in circulating the engine coolant. The engine coolant is configured to heat the LOX originating from the LOX storage tank 313 to aid in evaporating the LOX prior to entry into the ECE 319.

A switching valve 318 is disposed downstream of an exhaust side of the ECE 319 and is configured to route exhaust gases from the ECE 319 between two different flow paths. The switching valve 318 may be any three-way valve configured to switch the flow of the exhaust gases between the flow paths, as desired. A first flow path branching from the switching valve 318 leads directly to an exhaust (not shown) of the system 310 while a second flow path branching from the switching valve 318 redirects the exhaust gases through the heat exchanger 316 before joining the first flow path at a position downstream of the switching valve 318. The exhaust of the ECE system 310 may outlet the exhaust gases to the ambient environment, depending on the application of the ECE system 310.

In the present embodiment, the first flow path is formed by an exhaust fluid line 351 extending between and configured to provide fluid communication between the exhaust side of the ECE 319 and the exhaust of the ECE system 310. The exhaust fluid line 351 includes the switching valve 318 downstream of the ECE 319 and a branch point 355 downstream of the switching valve 318. An inlet fluid line 352 extends from the switching valve 318 to an inlet side of the heat exchanger 316 and is configured to convey a flow of the exhaust gases exiting the ECE 319 towards the heat exchanger 316 (depending on the instantaneous configuration/position of the switching valve 318). An outlet fluid line 353 extends from an outlet side of the heat exchanger 316 to the branch point 355. The outlet fluid line 353 is configured to convey the exhaust gases exiting the heat exchanger 316 to the exhaust fluid line 351 at the position downstream of the switching valve 318 where the exhaust gases can flow towards the exhaust of the ECE system 310.

The switching valve 318 is accordingly adjustable to determine whether the heat exchanger 316 is utilized for further heating the LOX therein prior to entry into the ECE 319 or whether the exhaust gases are directed exclusively towards the exhaust of the ECE system 310. For example, FIG. 9 illustrates the switching valve 318 when in a first position corresponding to the exhaust gases flowing towards the exhaust without being redirected through the heat exchanger 316 while FIG. 10 illustrates the switching valve 318 when in a second position corresponding to the exhaust gases flowing through the heat exchanger 316 before being directed to the exhaust.

A second throttle valve 317 is disposed downstream of the series arrangement of the heat exchangers 315, 316 and controls the flow rate of the heated LOX into the ECE 319. In order to reduce peak combustion temperatures, it may be necessary to utilize exhaust gas recirculation (EGR), as desired.

The ECE system 310 may include any number of sensors for monitoring a temperature and/or pressure of any of the LOX, the exhaust gases downstream of the ECE 319, or the coolant circulated through the coolant circuit associated with the heat exchanger 315. These sensors may be utilized to monitor the condition of all relevant fluids at each desired position in order to determine the amount of heat that must be transferred to the LOX and the conditions necessary within each of the heat exchangers 315, 316 for achieving this heat transfer. The associated controller may be configured to adjust the switching valve 318 based on a known temperature of one or more of the LOX prior to introduction into the heat exchanger 316, the LOX after exiting the heat exchanger 316, and/or the exhaust gases exiting the ECE 319. The controller may further be configured to adjust various aspects of the coolant circuit associated with the heat exchanger 315 in order to adjust the degree of heat exchange occurring within the heat exchanger 315, such as adjusting the heat exchange relationship of the coolant with the ECE 319, adjusting a flow rate of the coolant, or adjusting the flow configuration of the coolant through the associated circuit for altering a condition of the coolant, as desired.

In use, the valve 312 is configured to convey the LOX to the LOX storage tank 313 and the throttle valve 314 is configured to control a flow rate of the LOX flowing out of the storage tank 313 and towards the series arrangement of the heat exchangers 315, 316. The LOX is heated within the heat exchanger 315 by receiving heat energy from the coolant used to cool the ECE 319, assuming that the coolant is instantaneously being circulated through the fluid lines 322, 323. As mentioned above, the heating capacity of the heat exchanger 315 may be altered by altering operation of the coolant circuit having the coolant circulating therethrough, which may be dependent on the remainder of the vehicle or device utilizing the ECE system 310. The LOX may be further heated by receiving heat energy from the exhaust gases of the ECE 319 within the heat exchanger 316 depending on whether the switching valve 318 is diverting the exhaust gases from the ECE 319 through the heat exchanger 316 in the manner described above. One or both of the heat exchangers 315, 316 may accordingly be configured to evaporate the LOX so as to provide oxygen in gaseous form for combustion within the ECE 319. The throttle valve 317 is then configured to control the flow of the evaporated oxygen into the ECE 319 for performing combustion therein. All exhaust gases eventually flow to a position downstream of the switching valve 318 regardless of the position of the switching valve 318 for exiting the ECE system 310 through an exhaust.

One particular advantage of the ECE systems 10, 110, 210, 310 as disclosed herein relates to the manner in which the corresponding ECEs are able to be placed in fluid communication with any suitable source or sources of compressed intake gas while still operating according to the principles disclosed herein. That is, the manner in which the necessary compression of the intake gas is performed by a separate and external process to the combustion process occurring within the corresponding ECE(s) results in there being no need to have one-to-one correspondence between any compression sources and any ECEs forming the ECE system. In some implementations, a single compression source in the form of a compressor may be used to direct the compressed intake gas to a plurality of independently provided ECEs. Each of the independently provided ECEs in turn produces its own power that can then be delivered to a corresponding mechanism associated with the ECE system, such as a propeller shaft of a vehicle. In other implementations, two or more independently provided compression sources in the form of compressors may be used to direct pressurized intake gas to a single ECE, wherein the different compression sources may be provided to direct intake gases at different pressures to the single ECE. In yet other implementations, any combination of any number of compression sources may be selectively placed in fluid communication with any number of the ECEs, as desired, to accomplish the desired characteristics of the resulting ECE system.

The compressors forming the aforementioned compression source(s) may also be driven or otherwise powered by any mechanism or process associated with whatever device, structure, or mechanism is utilizing the corresponding ECE system. For example, such compressors are not limited to being powered by engine shaft power in the case of a vehicular application, and may instead be powered by a suitable gas or steam turbine, an ICE, an ECE, or an electric motor, as a non-exhaustive list of potential examples of power sources. The compressor(s) may be driven by one power source or may be powered by a combination of different power sources. Furthermore, one or more of the compressors may be powered by one or more of the power sources while another one or more of the compressors may be powered by another one or more of the power sources, as desired.

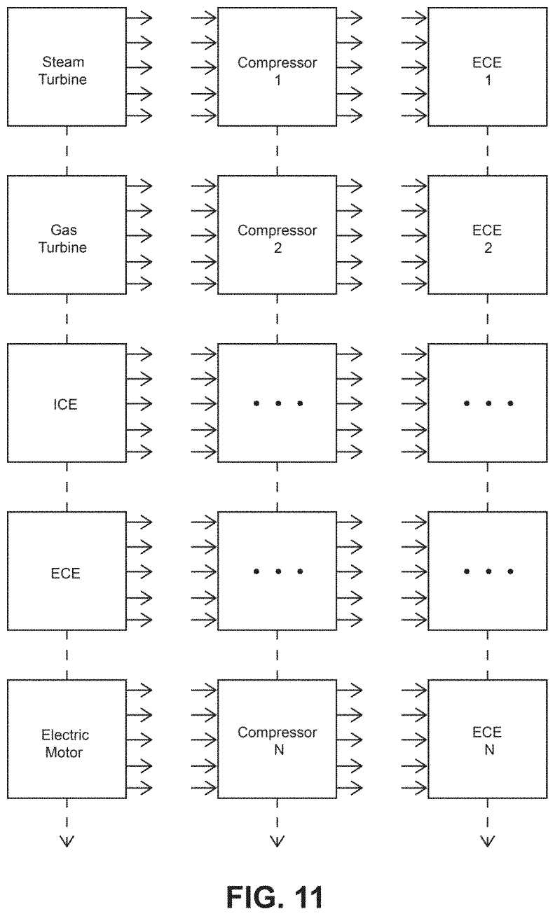

The potential flexibility of the ECE systems as disclosed herein is best illustrated by reference to FIG. 11, which shows the different possible configurations of the ECE systems as described above in graphical format. Any one or more of the power sources listed in the leftmost column (which is a non-exhaustive list) may be used to power any number of compressors as indicated within the middle column, which indicates that 1 to N of the compressors may be utilized. Additionally, any of the compressors utilized within the middle column may be placed in fluid communication with any of the ECEs of the rightmost column, which indicates that 1 to N of the ECEs may be utilized with the 1 to N compressors. The corresponding ECE system may accordingly utilize any power source with any number of power sources, any number of compressors, and any number of ECEs. Additionally, any combination of the power sources may be associated with any combination of the compressors, and any combination of the compressors may be associated with any combination of the ECEs.

The sources of pressurized intake gas are stated above as being provided in the form of compressors, but it is also within the scope of the present invention for one or more of the sources of pressurized intake gas to represent pressurized storage tanks or other fluid sources having previously compressed and pressurized intake gases disposed therein for selective communication with whatever ECEs are associated with the corresponding system. For example, such a pressurized tank could be supplemental in nature and may supplement a compressor in communication with the same ECE or ECEs. One or more of the pressurized tanks may represent a storage tank for accumulating pressurized intake gases that are compressed elsewhere within the corresponding system, such as is the case with the storage tank 216 of FIGS. 7 and 8. Alternatively, one or more of the pressurized tanks may be prefilled with a suitable fluid such as is the case with reference to the liquid oxygen storage tank 313 of FIGS. 9 and 10. As noted with reference to the examples referencing multiple compressors, such a system may include one pressurized tank and multiple ECEs, multiple pressurized tanks and a single ECE, or multiple pressurized tanks and multiple ECEs. With renewed reference to FIG. 11, the second column illustrating the possible compression sources for use with the corresponding drive systems and ECEs may accordingly be modified to include any number of compressors, any number of pressurized tanks or other fluid sources, and any combinations thereof, as desired, for use with any number and combination of power sources and outputting ECEs.

The use of multiple compressors and/or multiple ECEs may be beneficial for various applications of the disclosed ECE systems. For example, possible applications include typical multi-engine configurations, such as well drilling rigs which bring additional engines online as the drill gets deeper, multi-engine locomotives, known as “GEN SET” locomotives, which use four to six separate motor-generator sets to improve idle and light load fuel economy as well as emissions, and certain kinds of ships, as non-limiting examples. Another novel implementation may include the formation of a “composite” aircraft engine, comprising up to ten or more individual ECE motors supplied by a single efficient compressor, wherein the cost of this single compressor is shared by multiple engines.

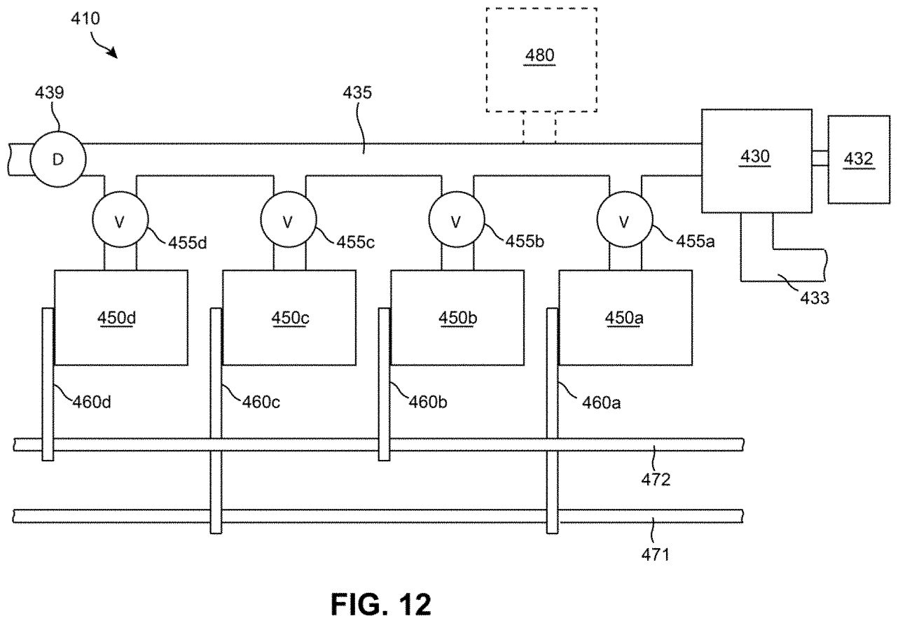

FIG. 12 illustrates one exemplary embodiment of an ECE system 410 utilizing multiple different ECEs 450a, 450b, 450c, 450d associated with a single compressor 430. The compressor 430 may be a multistage axial compressor that is driven by a gas turbine 432, as one example. However, other types of compressors or power sources may be utilized as described hereinabove while remaining within the scope of the present invention. The exemplary combination of the multistage axial compressor and the gas turbine may be selected because such a combination is relatively small, light, efficient, and very reliable. However, such a combination of components may also be relatively expensive, hence it is desirable to offset such costs by sharing these components among the plurality of different ECEs 450a, 450b, 450c, 450d with each of the ECEs 450a, 450b, 450c, 450d capable of being independently powered by the combination of the compressor 430 and the gas turbine 432.

The ECE system 410 further includes an intake conduit 433 and a manifold conduit 435. The intake conduit 433 directs intake gases to the compressor 430 where the intake gases are compressed to an increased pressure suitable for utilization within one of the ECEs 450a, 450b, 450c, 450d. The pressurized intake gases are then delivered to the manifold conduit 435. The manifold conduit 435 is in selective fluid communication with each of the ECEs 450 via corresponding valves 455a, 455b, 455c, 455d. Specifically, a first valve 455a selectively places the manifold conduit 435 in fluid communication with a first ECE 450a, a second valve 455b selectively places the manifold conduit 435 in fluid communication with a second ECE 450b, a third valve 455c selectively places the manifold conduit 435 in fluid communication with a third ECE 450c, and a fourth valve 455b selectively places the manifold conduit 435 in fluid communication with a fourth ECE 450d. Each of the valves 455a, 455b, 455c, 455d may be representative of a shut-off valve allowing for continued operation of the remainder of the ECE system 410 even in the event that operation of one of the ECEs 450a, 450b, 450c, 450d is interrupted, such as may be the case in the event of a failure of a component associated with one of the ECEs 450a, 450b, 450c, 450d. Alternatively, the valves 455a, 455b, 455c, 455d may be configured to selectively operate each of the ECEs 450a, 450b, 450c, 450d via selective fluid communication of each of the ECEs 450a, 450b, 450c, 450d with the pressurized intake gases contained within the manifold conduit 435. Such a configuration may be utilized when an increasing or decreasing number of the ECEs 450a, 450b, 450c, 450d are necessary for desired operation of the ECE system 410, such as when power demands are variable during operation of the ECE system 410. Each of the ECEs 450a, 450b, 450c, 450d may be representative of any type of ECE utilizing previously compressed intake gases for a combustion event in the manner described herein. The manifold conduit 435 may also be in fluid communication with a dump valve 439 configured to selectively depressurize the manifold conduit 435 by selectively venting the pressurized intake gases, thereby allowing for load-free starting and idling of the gas turbine 432.

The first ECE 450a and the third ECE 450c are each mechanically coupled to a first propeller shaft 471 while the second ECE 450b and the fourth ECE 450d are each mechanically coupled to a second propeller shaft 472. More specifically, a first mechanical coupling 460a mechanically couples the first ECE 450a to the first propeller shaft 471, a second mechanical coupling 460b mechanically couples the second ECE 450b to the second propeller shaft 472, a third mechanical coupling 460c mechanically couples the third ECE 450c to the first propeller shaft 471, and a fourth mechanical coupling 460d mechanically couples the fourth ECE 450d to the second propeller shaft 472. Each of the mechanical couplings 460a, 460b, 460c, 460d is representative of any mechanism or kinematic system capable of selectively transferring the linear reciprocating motion of the piston of the corresponding one of the ECEs 450a, 450b, 450c, 450d to the rotational motion of the corresponding one of the propeller shafts 471, 472 depending on an instantaneous configuration of the corresponding mechanical coupling 460a, 460b, 460c, 460d. Each of the mechanical couplings 460a, 460b, 460c, 460d may include a centrifugal clutch, an overrunning (“one-way”) clutch, a mechanical clutch, or the like, as non-limiting examples, for selectively transferring rotational motion generated by a connecting rod and crankshaft combination to the corresponding propeller shaft 471, 472. The use of clutch mechanisms allows for any one of the ECEs 450a, 450b, 450c, 450d to be operatively decoupled from the corresponding propeller shaft 471, 472 in the event that any of the ECEs 450a, 450b, 450c, 450d is not operating properly, thereby preventing the entire system from being unable to operate due to an isolated incident or failure. It should also be understood that the propeller shafts 471, 472 are merely exemplary mechanisms for transferring the power generated by the ECEs 450a, 450b, 450c, 450d, and that any alternative mechanisms utilizing any type of motion as powered by the ECEs 450a, 450b, 450c, 450d may be utilized according to the present embodiment. For example, alternative mechanisms may be conceived of that transfer the linear motion of the pistons to the linear motion of another mechanism or component, or that causes rotation about different axes than those shown, as desired. A clutch mechanism also does not necessarily need to be utilized with respect to any such mechanical coupling while remaining within the scope of the present invention.

The ECE system 410 beneficially allows for the single compressor 430 to power all four of the ECEs 450a, 450b, 450c, 450d in order to power two different propeller shafts 471, 472, wherein each of the propeller shafts 471, 472 may be responsible for powering different systems or mechanisms of whatever vehicle or device is associated with the ECE system 410. The use of the four different ECEs 450a, 450b, 450c, 450d is also merely exemplary, as any number of the ECEs may be associated with powering any number of the propeller shafts, including all of the ECEs being used to power a single propeller shaft. As mentioned above, the ECE system 410 may be configured to selectively utilize only those ECEs 450a, 450b, 450c, 450d (and in turn those propeller shafts 471, 472) that are instantaneously required for a given application via control of the valves 455a, 455b, 455c, 455d. Alternatively, the valves 455a, 455b, 455c, 455d may allow for the ECE system 410 to remain operable following the failure of one of the corresponding ECEs 450a, 450b, 450c, 450d or a component associated with operation with one of the ECEs 450a, 450b, 450c, 450d by acting as shut-off valves.

The versatility of the ECE system 410 may also include the manifold conduit 435 in fluid communication with one or more compressors in addition to the compressor 430 or one or more pressurized storage tanks having a previously compressed fluid contained therein, as desired. The different compressors and/or pressurized storage tanks may be utilized at times of increased demand or may be utilized to replace operation of another one of the compressors and/or pressurized storage tanks, as desired, depending on the instant application. An additional source of pressurized intake gas 480, which may represent either a compressor or a storage tank, is shown in phantom lines in FIG. 12 to illustrate how such an additional source of pressurized intake gas may be integrated into the ECE system 410. The source of pressurized intake gas 480 may be configured for selective fluid communication with the manifold conduit 435 to cause the source of pressurized intake gas 480 to be further configured for selective fluid communication with a combustion chamber of any one of the ECEs 450a, 450b, 450c, 450d. It should be apparent that additional sources of pressurized intake gas may be incorporated into the ECE system 410 in the same manner as the source 480 while remaining within the scope of the present invention.

Referring now to FIGS. 13-21, one particularly advantageous configuration of an ECE 50 is disclosed. The ECE 50 may be utilized as the ECE of any of the ECE systems shown or described herein. Additionally, the ECE 50 may also be configured for use with any variety of other ECE systems that differ from those shown and described herein, as it should be apparent that the advantageous features of the ECE 50 maintain their utility regardless of the upstream or downstream arranged components of the ECE system. The ECE 50 operates in the absence of a compression stroke as described hereinabove. That is, the ECE 50 utilizes a previously compressed and pressurized intake gas in performing a combustion event, wherein the previously compressed and pressurized intake gas is not subjected to compression within the ECE 50.

The ECE 50 generally includes an engine housing 52 in which a piston cylinder 54 acting as a combustion chamber is formed. The engine housing 52 is shown as a single continuous structure, but may alternatively be divided into an engine block and an engine head which are coupled together, as desired. A piston 60 is reciprocatingly disposed within the piston cylinder 54. The piston 60 includes a first surface 61 exposed to the interior of the piston cylinder 54. Any forces generated within the piston cylinder 54, including the pressure forces of any gases disposed within the piston cylinder 54 or any forces generated by the combustion of the intake gases, are applied to the first surface 61 of the piston 60. The first surface 61 is formed at a first end of the piston 60 while a second end of the piston 60 is disposed towards a crankshaft 80 of the ECE 50. The piston 60 is rotatably coupled to a first end of a connecting rod 70 while a second end of the connecting rod 70 is rotatably coupled to the crankshaft 80. As is standard, the linear reciprocating motion of the piston 60 within the piston cylinder 54 is transferred to rotational motion of the crankshaft 80 as a result of the orbiting of the second end of the connecting rod 70 relative to an axis of rotation of the crankshaft 80.

The piston cylinder 54 extends axially from a first end 55 to a second end 56. The piston 60 slides axially towards the first end 55 of the piston cylinder 54 when moving towards top dead center (TDC) and the piston 60 slides axially towards the second end 56 of the piston cylinder 54 when moving towards bottom dead center (BDC). The engine housing 52 further includes at least one intake passageway 57 formed therethrough and at least one exhaust passageway 58 formed therethrough.

Each of the intake passageways 57 forms a flow path through which the intake gases can enter the piston cylinder 54. In the illustrated embodiment, two of the intake passageways 57 are shown with each of the intake passageways 57 intersecting the first end 55 of the piston cylinder 54. However, any number of the intake passageways 57 may be formed through the engine housing 52 for delivering the intake gases, and the intake passageways 57 may be arranged in any desired configuration. Each of the intake passageways 57 may alternatively intersect the piston cylinder 54 at any position between the first surface 61 of the piston 60 when at TDC and the first end 55 of the piston cylinder 54, including intersecting a circumferential side surface of the piston cylinder 54, so long as the intake gases can be delivered to the piston cylinder 54 at a position wherein combustion of the intake gases applies a force on the first surface 61 for moving the piston 60 towards BDC.

Each of the intake passageways 57 includes a poppet valve 90 disposed therein. Each of the poppet valves 90 includes a valve head 91 configured to selectively allow or prevent fluid communication between the corresponding intake passageway 57 and the piston cylinder 54. Specifically, the valve head 91 moves into the piston cylinder 54 and away from the corresponding intake passageway 57 when allowing for the intake gases to enter the piston cylinder 54 and moves towards and engages a valve seat of the engine housing 52 around a perimeter of the corresponding intake passageway 57 when preventing the intake gases from entering the piston cylinder 54. Although poppet valves 90 are shown and described, any type of valve may be utilized for controlling the flow of the intake gases into the piston cylinder 54 through the corresponding intake passageways 57 without departing from the scope of the present invention.

Each of intake passageway 57 and poppet valve 90 combinations described above may generally be referred to hereinafter as an intake valve of the ECE 50. Each of the intake valves may be configured to actuate to the open or closed positions thereof based on a position of the piston 60 and the corresponding position of the crankshaft 80. For example, a cam system may be mechanically linked to the crankshaft 80 and each of the intake valves such that each of the intake valves is open with respect to certain rotational positions of the crankshaft 80 and closed with respect to other rotational positions thereof, as explained in greater detail hereinafter. However, alternative methods may be utilized to control the timing of the intake valves without necessarily departing from the scope of the present invention.

Each of the exhaust passageways 58 forms a flow path through which the exhaust gases generated following a combustion event within the piston cylinder 54 can exit the piston cylinder 54. Each of the exhaust passageways 58 extends radially outwardly from the circumferential side surface of the piston cylinder 54 at a position between the first surface 61 of the piston 60 when at BDC and the first end 55 of the piston cylinder 54. The exhaust passageways 58 are generally disposed adjacent the second end 56 of the piston cylinder 54, and must be disposed closer to the second end 56 than the intake passageways 57 in order for the ECE 50 to operate as described hereinafter.

The fluid communication between the piston cylinder 54 and each of the exhaust passageways 58 is controlled based on the axial position of the piston 60 within the piston cylinder 54. Specifically, the exhaust passageways 58 begin to open as the first surface 61 of the piston 60 first reaches the exhaust passageways 58 in the axial direction when the piston 60 is moving in a direction from TDC towards BDC, are fully open when the piston 60 reaches BDC, begin to close when the first surface 61 first reaches the exhaust passageways 58 in the axial direction when the piston 60 is moving in a direction from BDC towards TDC, and are fully closed when the first surface 61 passes beyond the exhaust passageways 58 when continuing to move towards TDC. The exhaust passageways 58 are accordingly not controlled by an independently provided valve mechanism, but are instead controlled based on the axial position of the piston 60 within the piston cylinder 54. Each of the exhaust passageways 58 may accordingly be referred to hereinafter as an exhaust port of the ECE 50.

As mentioned previously, the ECE 50 of the present invention may include the intake gas mixed with a fuel immediately upstream of the piston cylinder 54 or the intake gas may be mixed with the fuel within the piston cylinder 54, as desired. For example, FIG. 13 illustrates a component 95 that may be representative of a spark plug or a combination of a fuel injector and spark plug assembly, depending on the instantaneous application. If the fuel is added to the intake gas upstream of the piston cylinder 54, then the component 95 may be representative of a spark plug in the absence of a fuel injecting structure. Alternatively, if the fuel is to be added to the intake gas within the piston chamber 54, the component 95 may be representative of an assembly including a fuel injecting structure and a spark plug. The intake gas may be introduced into the piston cylinder 54 for mixing with the previously compressed intake gas at any time during the disclosed intake stroke of the piston 60

If the engine housing 52 is divided into the engine head and the engine block, the first end 55 of the piston cylinder 54 may be defined by the engine head while the second end 56 thereof may be defined by the engine block. Additionally, each of the intake passageways 57 may be formed through the engine head while each of the exhaust passageways 58 may be formed through the engine block. The engine block may also include fluid passageways for communicating a coolant through the engine housing 52, as desired. However, the engine housing 52 may be assembled via any combination of structures so long as the features of the ECE 50 as described hereinafter are able to be carried out by the resulting engine housing 52 via the described flow paths formed therethrough.

The manner in which the flow through the piston cylinder 54 always passes from the intake valves adjacent the first end 55 thereof towards the exhaust ports adjacent the second end 56 thereof results in the ECE 50 having what is commonly referred to as a uniflow engine flow configuration. The uniflow engine flow configuration is beneficial as valves as well as any corresponding components or mechanisms used to control the valves are only required with respect to the intake of the gases into the piston cylinder 54, which aids in simplifying the manufacturing of the ECE 50 while also lowering the cost thereof. However, as should be apparent from a review of FIGS. 13-21, the timing of the exhaust stroke must be formed to be symmetric about BDC due to the manner in which the piston 60 fully covers and initially uncovers the exhaust passageways 58 at the same axial positions of the piston 60 regardless of the direction of movement of the piston 60.

FIGS. 13, 14, 16, 17, 19, and 20 illustrate six different positions of the piston 60 and the crankshaft 80 corresponding to progressive positions of the crankshaft 80 when undergoing a cycle of the ECE 50. FIGS. 15, 18, and 21 are diagrams showing how each of the six different positions of the crankshaft 80 correspond to what are referred to as an intake stroke, a power stroke, and an exhaust stroke of the ECE 50. As is apparent from review of FIGS. 13-21, the crankshaft 80 rotates in a clockwise direction from the perspective of the provided figures when the piston 60 repeatedly reciprocates between TDC and BDC. As described throughout, the ECE 50 is distinguished from a traditional 2-stroke engine by virtue of the elimination of the compression stroke that normally occurs prior to the power stroke. Instead, the intake gases are compressed upstream of the ECE 50 and the relatively higher pressure of the compressed intake gases causes the intake gases to flow into the relatively lower pressure piston cylinder 54 whenever the intake valves are opened during the intake stroke.

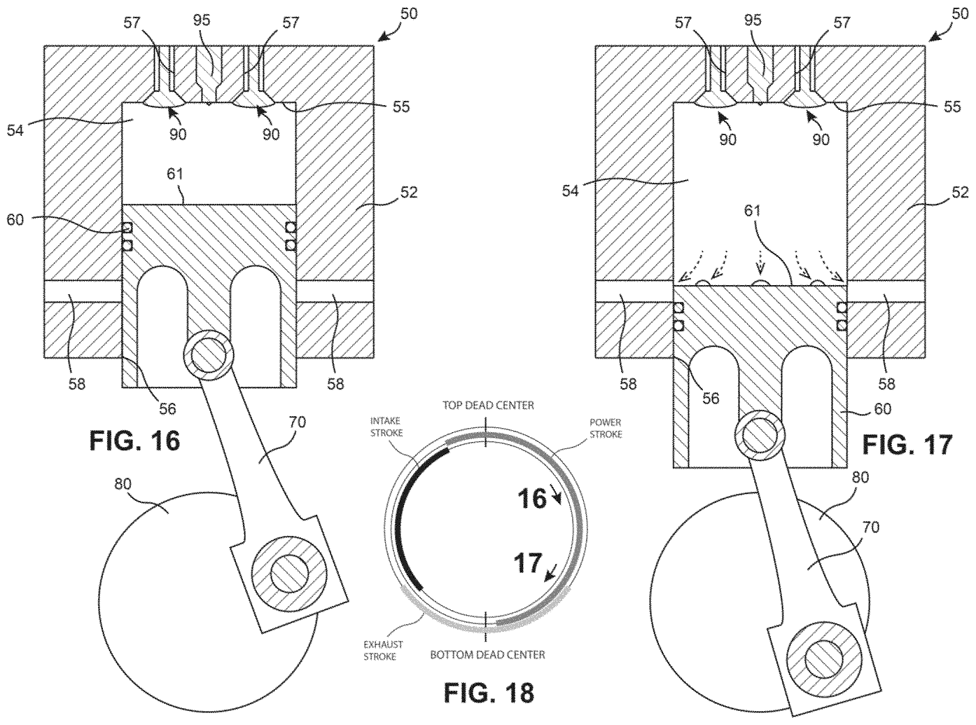

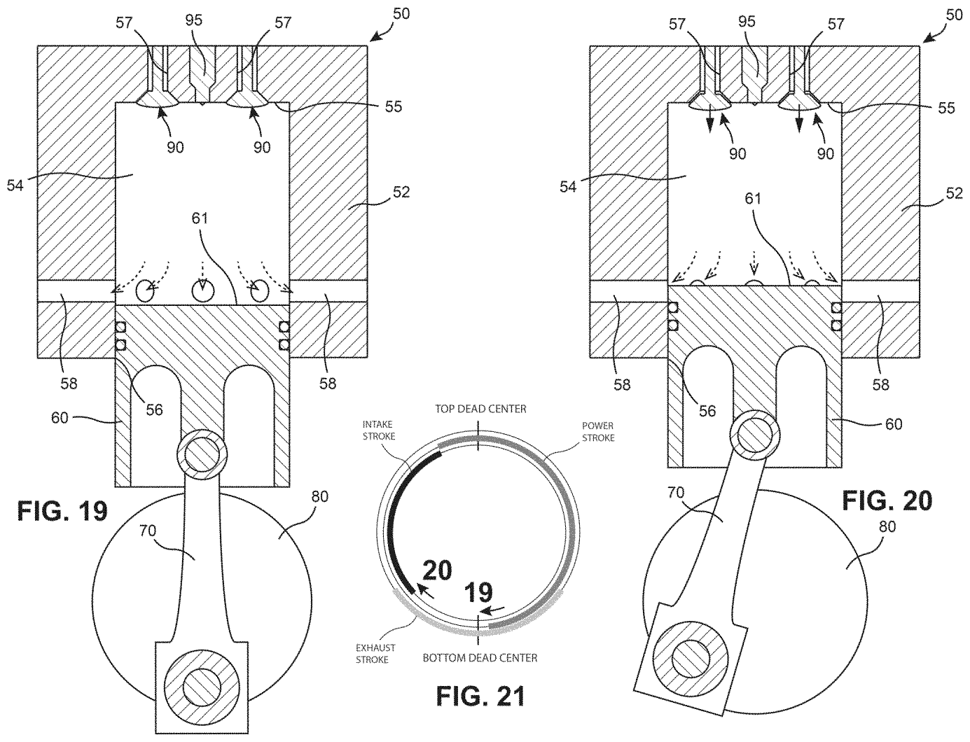

FIG. 13 illustrates the piston 60 when approaching TDC with the poppet valves 90 open to allow the intake gases to enter the piston cylinder 54 through the intake passageways 57. The exhaust passageways 58 are covered by the piston 60 to prevent the escape of the intake gases therethrough. The fuel may also be introduced into the piston cylinder 54 during the intake stroke for mixing the fuel with the previously compressed intake gas entering the piston cylinder 54. FIG. 14 illustrates the piston 60 when at TDC with the poppet valves 90 closed to prevent backflow into the intake passageways 57 following the combustion of the intake gas and fuel mixture via the spark plug 95 disposed at the first end 55 of the piston cylinder 54. The combustion of the intake gas and fuel mixture applies a force to the first surface 61 of the piston 60 for causing the piston 60 to move downwardly towards BDC during the power stroke. FIG. 16 illustrates the piston 60 in a middle portion of the power stroke when continuing to move downwardly towards BDC following the combustion of the intake gas and fuel mixture. FIG. 17 illustrates the piston 60 at a position corresponding to an overlap between the power stroke and the exhaust stroke. Specifically, the first surface 61 of the piston 60 has partially passed by the exhaust passageways 58 to allow the exhaust gases generated by the combustion of the intake gases to begin to flow out of the piston cylinder 54 while the piston 60 continues to move downwardly towards BDC. FIG. 19 illustrates the piston 60 when at BDC with each of the exhaust passageways 58 fully open to allow the exhaust gases to continue flowing out of the piston cylinder 54. FIG. 20 illustrates the piston 60 at a position symmetric to that shown in FIG. 17 with the first surface 61 of the piston 60 almost fully closing off the exhaust passageways 58 during movement of the piston 60 upwardly back towards TDC. Additionally, FIG. 20 also shows an overlap between the exhaust stroke and the intake stroke as the poppet valves 90 are beginning to open in order to once again allow the intake gases to flow into the piston cylinder 54. This process is repeated during operation of the ECE 50 to continuously provide power to the crankshaft 80 for rotating any corresponding components of whatever device is being powered by the ECE 50.

It is important to note that the disclosed ECE 50 is not the only ECE configuration suitable for use in the systems disclosed herein. For example, a contrary stroke configuration such as is disclosed in FIG. 1 may alternatively be utilized while remaining within the scope of the present invention. Any other such ECE configuration may include the use of valves at each of the intake passageways and the exhaust passageways, as desired, and may further include the intake passageways and the exhaust passageways having different locations relative to the positions of the corresponding piston. For example, both the intake valves and the exhaust valves may be formed at a common end of the corresponding piston cylinder having the spark plug, wherein the intake valves and the exhaust valves are timed to open and close according to a stroke configuration such as that disclosed in FIG. 1. Such a stroke configuration does not require the need for the exhaust stroke to be symmetric relative to BDC, and can instead include the exhaust stroke beginning much closer to BDC as a result. However, in all cases, the corresponding ECE must eliminate the use of a compression stroke to be consistent with the ECE systems disclosed herein, wherein the intake gases are instead compressed at a position upstream of the ECE with respect to the corresponding ECE system.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An external compression engine system comprising:
an external compression engine configured to operate without a compression stroke within a combustion chamber thereof; and
at least one source of pressurized intake gas, each of the at least one sources of pressurized intake gas configured to be placed in selective fluid communication with the combustion chamber of the external compression engine.

2. The external compression engine system of claim 1, wherein the at least one source of pressurized intake gas is a first compressor, wherein an intercooler is disposed downstream of the first compressor with respect to a flow of the pressurized intake gas, and wherein a bypass flow path is configured to selectively bypass the intercooler with respect to the flow of the pressurized intake gas.

3. The external compression engine system of claim 1, wherein the at least one source of pressurized intake gas is a first compressor, and wherein the external compression engine does not have a fixed mechanical relationship with the first compressor.

4. The external compression engine system of claim 3, wherein the external compression engine is configured to drive a generator, and wherein power generated within the generator is transferred to an electrical motor configured to drive the first compressor.

5. The external compression engine system of claim 3, wherein a mechanical continuously variable transmission mechanically couples the first compressor to the external compression engine.

6. The external compression engine system of claim 1, wherein the at least one source of pressurized intake gas includes a first compressor and a storage tank, wherein the combustion chamber of the external compression engine is selectively placed in fluid communication with one of the first compressor or the storage tank.

7. The external compression engine system of claim 6, further comprising a second compressor configured to supply pressurized intake gas to the storage tank.

8. The external compression engine system of claim 6, wherein placing the combustion chamber of the external compression engine in fluid communication with the storage tank results in a power boost to the external compression engine.

9. The external compression engine system of claim 1, wherein the at least one source of pressurized intake gas is a liquid oxygen storage tank configured to store a quantity of liquid oxygen, and wherein the external compression engine system further comprises at least one heat exchanger disposed between the liquid oxygen storage tank and the external compression engine, wherein each of the at least one heat exchangers is configured to heat the liquid oxygen to vaporize the liquid oxygen prior to entry into the external compression engine.

10. The external compression engine system of claim 9, wherein the at least one heat exchanger is in heat exchange relationship with a coolant used to cool the external compression engine.

11. The external compression engine system of claim 9, wherein the at least one heat exchanger is in heat exchange relationship with exhaust gases exiting the external compression engine.

12. The external compression engine system of claim 11, wherein a valve controls the flow of the exhaust gases through the at least one heat exchanger.

13. An external compression engine configured to operate in the absence of a compression stroke, the external compression engine comprising:
an engine housing having a piston cylinder formed therein, the piston cylinder extending axially from a first end to a second end;
a piston reciprocatingly disposed within the piston cylinder;
at least one intake valve disposed in the engine housing adjacent the first end of the piston cylinder, each of the at least one intake valves selectively allowing for intake gas to enter the piston cylinder; and
at least one exhaust port formed in the engine housing adjacent the second end of the piston cylinder, each of the at least one exhaust ports selectively allowing for exhaust gas formed within the piston cylinder to exit the piston cylinder based on an axial position of the piston within the piston cylinder.

14. The external compression engine of claim 13, wherein each of the intake valves includes a poppet valve disposed within an intake passageway.

15. The external compression engine of claim 13, wherein each of the exhaust passageways is formed in a circumferential side surface of the piston cylinder.

16. The external compression engine of claim 15, wherein an exhaust stroke of the piston occurs symmetrically relative to a bottom dead center position of the piston within the piston cylinder.

17. An external compression engine system comprising:
at least one source of pressurized intake gas;
a first external compression engine in selective fluid communication with each of the at least one sources of pressurized intake gas;
a second external compression engine in selective fluid communication with each of the at least one sources of pressurized intake gas;
a first propeller shaft selectively mechanically coupled to one or both of the first external compression engine and the second external compression engine.

18. The external compression engine system of claim 17, wherein a manifold conduit fluidly couples each of the at least one sources of pressurized intake gas to the first external compression engine and the second external compression.

19. The external compression engine system of claim 17, wherein the at least one source of pressurized intake gas includes a plurality of the sources of pressurized intake gas.

20. The external compression engine system of claim 17, further comprising a second propeller shaft, wherein the first propeller shaft is selectively mechanically coupled to the first external compression engine and the second propeller shaft is selectively mechanically coupled to the second external compression engine.
